(19) United States
(12) Patent Application Publication
(10) Pub. No.: US 2021/0025404 A1
(43) Pub. Date: Jan. 28, 2021

(54) ELECTRIC PUMP WITH CUSTOMIZABLE ACCESSORIES

(71) Applicant: DAB PUMPS S.P.A., Mestrino (IL)

(72) Inventors: Francesco SINICO, Montecchio Maggiore (IT); Francesco CIUCHI, Pontedera (IT); Yuri FULCERI, Cecina (IT)

(73) Assignee: DAB PUMPS S.P.A., Mestrino (IT)

(21) Appl. No.: 16/935,785

(22) Filed: Jul. 22, 2020

(30) Foreign Application Priority Data
Jul. 25, 2019 (IT) 102019000012849

(51) Int. Cl. F04D 29/40; F04D 13/06; F04D 29/043; F04D 29/20

(52) U.S. Cl. CPC F04D 29/406; F04D 13/0693; F04D 13/08; F04D 29/20; F04D 29/043

(57) ABSTRACT

An electric pump comprising:
a containment shell,
a wet section, comprising an intake portion, a delivery portion and one or more impellers keyed on a shaft, the one or more impellers being interposed between the intake portion and the delivery portion,
an electromechanical section, comprising motor means for the movement of the shaft,
an electronic section, comprising a compartment inside which an to actuation and control assembly is contained, the actuation and control assembly having an electrical board.

The actuation and control assembly comprises communication means of the NFC type.

The present invention relates to an electric pump with customizable accessories.

Electric pumps of the submersed and surface type are currently known which can have a plurality of accessories, such as for example a level sensor, a local user interface, a float for activation of non-continuous operation.

Usually these accessories are connected to the actuation and control assembly of the pump, which manages their operation, by means of a to physical electrical connection.

These known methods have some drawbacks.

These electric pumps of the known type comprise an assembly for the actuation and control of the pump, which contains the electronic components that are useful for the operation of the pump and is contained in is a compartment that has at least two through openings and/or holes adapted for communication with the outside of the actuation and control assembly:
a first opening and/or hole for the passage of the electric power supply cable;
a second opening and/or hole for the passage of the electrical cable for connection to one or more accessories.

This causes the need to make provisions, during designing step, for these two openings/holes by arranging them appropriately and then providing them during production, causing manufacturing difficulties.

Furthermore, this causes the need to use multiple solutions to insulate/seal the compartment that contains the actuation and control assembly and ensure its tightness.

In the case of a submersed electric pump, for example, infiltrations of water both from the opening/hole for the power supply cable and from the opening/hole for the cable for connection to an accessory may occur.

Finally, another drawback is constituted by the fact that the user must predict, before purchase, which accessories he will need and cannot customize the accessories at a later time, since they are assembled during production and cannot be removed/modified at a later stage.

The aim of the present invention is to provide an electric pump that is capable of improving the background art in one or more of the aspects indicated above.

Within this aim, an object of the invention is to provide an electric pump with accessories that can be customized by the user after purchase and can be easily installed by the latter.

Another object of the invention is to provide an electric pump that has an actuation and control assembly with a lower risk of infiltrations from the outside and which therefore requires a smaller number of solutions in order to ensure its tightness.

A further object of the invention is to provide an electric pump that allows the user to customize his accessories and is easier and simpler to provide with respect to similar pumps of the known type.

Another object of the invention is to provide an electric pump with accessories that can be customized by the user which comprises a compartment for the containment of the actuation and control assembly that has a single through opening that communicates with the outside.

A further object of the present invention is to overcome the drawbacks of the background art in a manner that is alternative to any existing solutions.

Another object of the invention is to provide an electric pump with customizable accessories that is highly reliable, relatively easy to provide and at competitive costs.

This aim, as well as these and other objects which will become better apparent hereinafter, are achieved by an electric pump comprising:
a containment shell,
a wet section, comprising an intake portion, a delivery portion and one or more impellers keyed on a shaft, said one or more impellers being interposed between said intake portion and said delivery portion,
an electromechanical section, comprising motor means for the movement of said shaft,
an electronic section, comprising a compartment inside which an actuation and control assembly is contained, said actuation and control assembly having an electrical board,

said electric pump being characterized in that said actuation and control assembly comprises communication means of the NFC type.

Further characteristics and advantages of the invention will become better apparent from the description of a preferred but not exclusive embodiment of the electric pump according to the invention, illustrated by way of non-limiting example in the accompanying drawings, wherein:

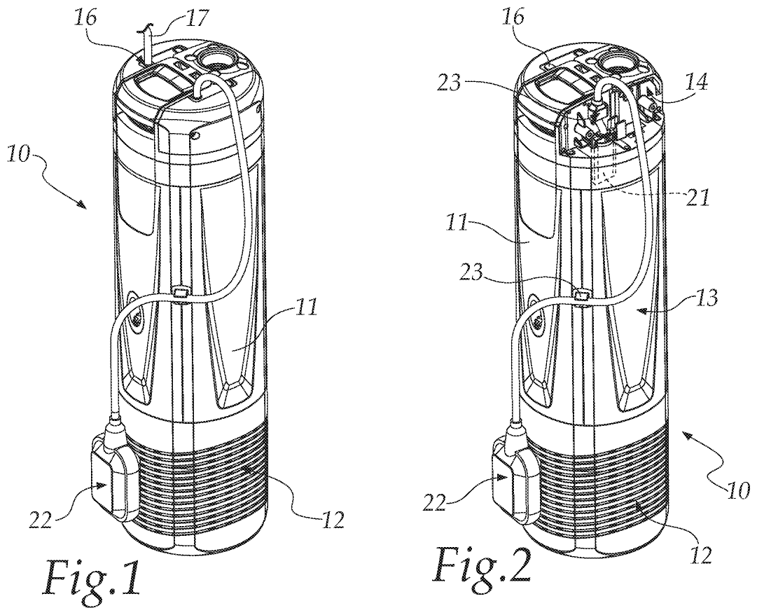

FIG. 1 is a general view of an electric pump according to the invention;

FIG. 2 is a partially disassembled view of the electric pump of FIG. 1;

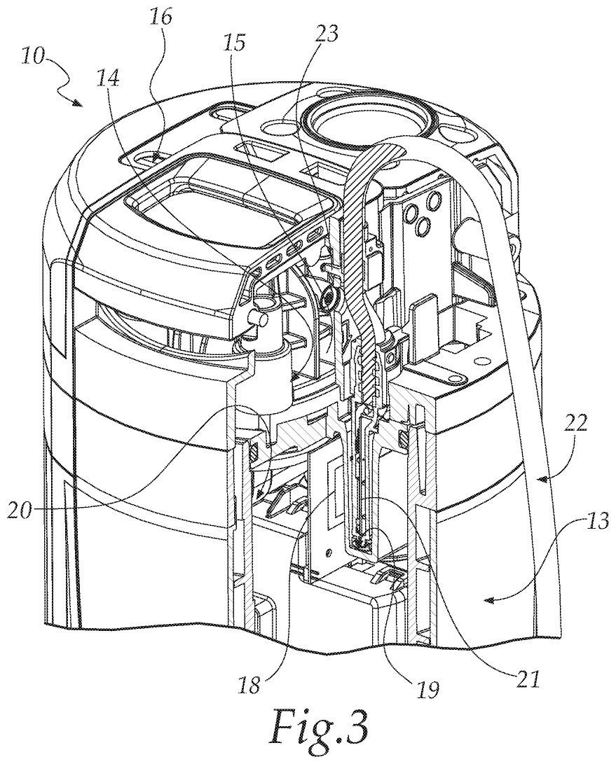

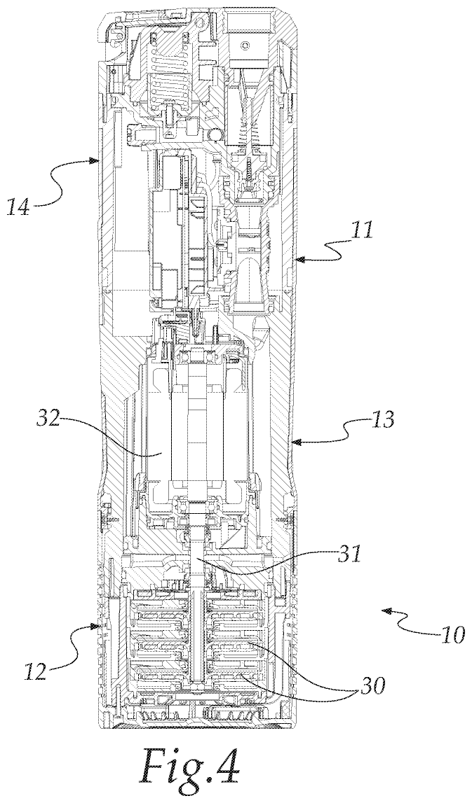

FIG. 3 is a sectional view of a detail of the electric pump of FIG. 1;

FIG. 4 is a sectional view of the electric pump of FIG. 1.

With reference to the figures, an electric pump according to the invention is designated generally by the reference numeral 10.

In the illustrated example, the electric pump 10 is of the submersed type; however, the invention is also applicable to surface electric pumps.

The electric pump 10 comprises a containment shell 11.

The electric pump 10 comprises:
a wet section 12, comprising an intake portion and a delivery portion, both not shown in the figures, and one or more impellers 30 keyed on a shaft 31 and interposed between the intake portion and the delivery portion,
an electromechanical section 13, which comprises motor means 32 adapted for the movement of the shaft 31,
an electronic section 14, which comprises a compartment 20 inside which an assembly 15 for the actuation and control of the electric pump 10 is contained, said assembly having an electrical board.

The compartment 20 has a single opening/hole 16 for communication between the inside of the compartment 20 and the outside of the electric pump 10.

The opening/hole 16 is intended exclusively for the passage of a cable 17 for the electric power supply of the electric pump 10.

The electric power supply cable 17 is connected to the actuation and control assembly 15 of the electric pump 10.

The seal of the electronic section 14 is ensured, proximate to and/or at the opening/hole 16, by the presence of sealing elements, not shown in the figures, such as O-rings and/or gaskets.

One of the particularities of the invention resides in that the actuation and control assembly 15 comprises communication means of the NFC (Near-Field Communication) type.

In the illustrated example, said communication means of the NFC type is an antenna 18.

The electric pump 10 comprises mechanical means for the coupling of one or more accessories 22, which comprise corresponding complementary mechanical means.

In particular, the antenna 18 is arranged proximate to a receptacle 19 which is internal to the electronic region 14 and can be accessed from the outside of the shell 11 but is external to the compartment 20.

The receptacle 19 is adapted for the insertion of a corresponding device 21 of the NFC type.

The device 21 is arranged at a portion, for example one end, of an accessory 22.

In the example shown in the figures, the accessory 22 is a floating switch for the non-continuous operation of the electric pump.

Other possible accessories, not shown in the figures, are for example: level sensors, local user interface, sensors for estimating the quantity of water in a tank.

By virtue of the NFC communication between the antenna 18 of the actuation and control assembly 15 and the device 21 of the accessory 22, it is possible to install one or more accessories 22 on the electric pump 10 without the need to connect them physically/electrically to the electrical to board of the actuation and control assembly 15 and therefore without the need for a further opening/hole in the compartment 20.

This allows at the same time to reduce the risk of infiltrations within the compartment 20 and therefore to use a smaller number of solutions to ensure its tightness with respect to similar electrical pumps of the known type.

Furthermore, the user can purchase the electric pump 10 and decide later whether to purchase and install accessories 22 and if so which ones.

By virtue of the NFC communication between the antenna 18 of the actuation and control assembly 15 and the device 21 of the accessory 22, the user can install autonomously and easily any accessory 22 on the electric pump 10.

In particular, the receptacle 19 has such a shape and dimensions as to be substantially shaped complementarily to the device 21, so as to ensure easy insertion and coupling of the device 21 inside it.

The accessory 22, after the engagement of the device 21 in the receptacle 19, is optionally anchored to the body of the electric pump 10 and/or to its shell 11 by virtue of fixing elements 23, of a per se known type, such as for example pins, screws, supports for interlocking in the shell 11.

The device 21 has a substantially quadrangular profile and is substantially flat.

In constructive variations not shown in the figures, the enclosure of the accessory 22 can coincide with the enclosure of the device 21.

The operation of the electric pump 10 according to the invention is as follows.

The user, after purchasing the electric pump 10, even years later, can purchase an accessory 22 thereof.

In order to install the accessory 22 on the electric pump 10 it is sufficient to insert the device 21 of the accessory 22 in the receptacle 19 of the electronic section 14 of the electric pump 10.

By virtue of the NFC connection between the antenna 18 of the actuation and control assembly 15 and the device 21 of the accessory 22, the accessory communicates with, and is managed by, the actuation and control assembly 15 without the need for a physical/electrical connection between the two, as instead occurs in similar electric pumps of the known type.

In practice it has been found that the invention achieves the intended aim and objects, providing an electric pump with accessories that can be customized by the user after purchase and can be easily installed by the latter.

The invention provides an electric pump that has a compartment for the containment of the actuation and control assembly with a smaller risk of infiltrations from the outside with respect to similar electric pumps of the known type and which therefore requires a smaller number of solutions to ensure its tightness.

The invention also provides an electric pump that allows the user to customize his accessories and is easier and simpler to provide with respect to similar pumps of the known type.

Finally, the invention provides an electric pump with accessories that can be customized by the user which comprises a compartment that contains the actuation and control assembly which has a single through opening which communicates with the outside.

The invention thus conceived is susceptible of numerous modifications and variations, all of which are within the scope of the appended claims; all the details may furthermore be replaced with other technically equivalent elements.

In practice, the materials used, so long as they are compatible with the specific use, as well as the contingent shapes and dimensions, may be any according to the requirements and the state of the art.

The disclosures in Italian Patent Application No. 102019000012849 from which this application claims priority are incorporated herein by reference.

What is claimed is:

1. An electric pump comprising:
a containment shell,
a wet section, comprising an intake portion, a delivery portion and one or more impellers keyed on a shaft, said one or more impellers being interposed between said intake portion and said delivery portion,
an electromechanical section, comprising motor means for the movement of said shaft,
an electronic section, comprising a compartment inside which an to actuation and control assembly is contained, said actuation and control assembly having an electrical board,
wherein said actuation and control assembly comprises communication means of the NFC type.

2. The electric pump according to claim 1, further comprising at least one accessory which comprises a device of the NEC type.

3. The electric pump according to claim 2, further comprising mechanical means for the coupling of said at least one accessory, said at least one accessory comprising corresponding complementary mechanical means.

4. The electric pump according to claim 1, wherein said compartment has a single opening/hole for communication between the inside of said compartment and the outside of said electric pump, said opening/hole being exclusively suitable for the passage of a cable for the electric power supply of said electric pump.

5. The electric pump according to claim 2, wherein said communication means of the NEC type are arranged proximate to a receptacle for said device, said receptacle being internal to said electronic section and accessible from the outside of said shell but external to said compartment.

6. The electric pump according to claim 2, wherein said device is arranged at an end portion of said at least one accessory.

7. The electric pump according to claim 2, wherein said device has a substantially quadrangular profile and is substantially flat.

8. The electric pump according to claim 5, wherein said receptacle has such a shape and dimensions as to be substantially shaped complementarily to said device.

9. The electric pump according to claim 2, wherein said accessory is anchored to the body of said electric pump an/or to said shell by virtue of fixing elements.

10. An accessory for an electric pump according to claim 1, further comprising a device of the NFC type.
